(19) United States
(12) Patent Application Publication
(10) Pub. No.: US 2013/0250758 A1
(43) Pub. Date: Sep. 26, 2013

(54) BASE STATION, WIRELESS END DEVICE, AND TRANSMISSION BARRING METHODS THEREOF

(71) Applicant: INSTITUTE FOR INFORMATION INDUSTRY, Taipei (TW)

(72) Inventors: Chiu-Wen CHEN, Taipei City (TW); Chun-Yen HSU, Minxiong Township (TW)

(73) Assignee: INSTITUTE FOR INFORMATION INDUSTRY, Taipei (TW)

(21) Appl. No.: 13/803,968

(22) Filed: Mar. 14, 2013

Related U.S. Application Data
(60) Provisional application No. 61/615,213, filed on Mar. 24, 2012.

(51) Int. Cl. H04W 28/02

(52) U.S. Cl. CPC H04W 28/0231
USPC 370/230

(57) ABSTRACT

A base station, a wireless end device, and transmission barring methods are provided. The base station is configured to receive a special event notification message from a core network, generate a barring message after receiving the special event notification message, and transmit the barring message to the wireless end device. The base station is not overloaded when the barring message is generated and transmitted. After receiving the barring message, the wireless end device is suspended from transmitting data to the base station for a barring time interval.

### PRIORITY

This application claims the benefit of U.S. Provisional Application Ser. No. 61/615,213 filed on Mar. 24, 2012, which is hereby incorporated by reference in its entirety.

### FIELD

The present invention relates to a base station, a wireless end device, and transmission barring methods thereof; more particularly, the present invention relates to a base station, a wireless end device, and transmission barring methods thereof for dealing with data transmissions when a special event (i.e. a event that may cause a huge amount of data transmission) happens or is going to happen.

### BACKGROUND

A conventional wireless communication network 1 is illustrated in FIG. 1, which comprises a core network 11, two base stations 131, 133, and a plurality of wireless end devices 151, 153, 171, 173. The wireless communication network 1 may conform to Long Term Evolution (LTE) standard, Worldwide Interoperability for Microwave Access (WiMAX) standard, or other wireless communication standard that is familiar to people ordinary skilled in the art.

The base stations 131, 133 are electrically connected to the core network 11. The wireless end devices 151, 153 are in the coverage 12 of the base station 131, while the wireless end devices 171, 173 are in the coverage 14 of the base station 133. Among the wireless end devices 151, 153, 171, 173, the wireless end devices 151, 171 are user equipments (e.g. mobile phones) and the wireless end devices 153, 173 are delay tolerant devices (e.g. smart meters) that simply periodically transmit collected data to the core network 11 via the base stations 131, 133.

When an emergency event (e.g. a disaster like earthquake and tsunami) happens, huge amount of uplink data (e.g. emergency calls and/or emergency text messages from the wireless end devices 151, 171 to other wireless end devices via the base stations 131, 133, and the regularly collected data from the wireless end devices 153, 173 to the core network 11 via the base stations 131, 133) are transmitted expectedly in the wireless communication network 1.

Huge amount of uplink data transmissions usually causes the base stations 131, 133 and/or the core network 11 overload. Specifically, random access channel (RACH) processing resources at the base stations 131, 133 will be impacted, which may result in discard of the messages for attachments (e.g. scheduling information (e.g. Msg3 in the LTE standard) transmission failure). The consequence of which is that some of the wireless end devices 151, 153, 171, 173 may not be able to attach to the base stations 131, 133 and/or to make emergency calls.

Moreover, for the wireless end devices 151, 153, 171, 173 that have attached to the base stations 131, 133, some of them may be in the idle mode. For the aforementioned kinds of wireless end devices 151, 153, 171, 173, processing resources for idle-to-active signals and/or re-registering signals at the core network 11 will be impacted. For example, S1-AP message and/or non-access stratum (NAS) message may be discarded. The consequence of which is that some of the wireless end devices 151, 153, 171, 173 cannot turn into the active mode from the idle mode and/or re-register to the core network 11.

In addition to the problem of overload, huge amount of uplink data transmissions may also cause intolerable transmission delays, packet loss, or even service un-availability (e.g. emergency and/or high-priority call drops).

Consequently, for a special event (e.g. an emergency event, an event for new year's countdown, etc.) that may cause a huge amount of data transmission in a wireless communication network, a mechanism for managing data transmissions to prevent network from overloading is still in an urgent need.

### SUMMARY

To solve the aforementioned problems, the present invention provides a base station, a wireless end device, and transmission barring methods thereof.

The base station of certain embodiments of the present invention comprises a first transceiving interface, a processor, and a second transceiving interface, wherein the processor is electrically connected to the first and second transceiving interfaces. The first transceiving interface is configured to receive a special event notification message from a core network. The processor is configured to generate a barring message after the first transceiving interface receives the special event notification message. The second transceiving interface is configured to transmit the barring message to at least one wireless end device to suspend the wireless end device from transmitting data to the base station for a barring time interval. The base station is not overloaded when the barring message is generated and transmitted.

The wireless end device of certain embodiments of the present invention comprises a transceiving interface and a processor, wherein the transceiving interface is electrically connected to the processor. The transceiving interface is configured to receive a barring message from a base station. The processor is configured to suspend the transceiving interface from transmitting data to the base station for a barring time interval. The base station is not overloaded when the barring message is received by the wireless end device.

The transmission barring method of certain embodiments of the present invention is for use in a base station. The base station comprises a first transceiving interface, a second transceiving interface, and a processor. The transmission barring method comprises the following steps of: receiving a special event notification message from a core network by the first transceiving interface, generating a barring message by the processor after receiving the special event notification message, and transmitting the barring message to at least one wireless end device by the second transceiving interface to suspend the wireless end device from transmitting data to the base station for a barring time interval. The base station is not overloaded when the barring message is generated and transmitted.

The transmission barring method of certain embodiments of the present invention is for use in a wireless end device. The wireless end device comprises a transceiving interface and a processor. The transmission barring method comprises the following steps of: receiving a barring message from a base station by the transceiving interface and suspending the transceiving interface from transmitting data to the base station for a barring time interval by the processor. The base station is not overloaded when the barring message is received by the wireless end device.

In certain embodiments of the present invention, a special event notification message is generated by the core network when a special event (e.g. emergency event, an event for new year's countdown, etc.) that may cause a huge amount of data transmission happens or is going to happen. After the base station receives the special event notification message from the core network, the base station will generate a barring message and transmits the barring message to some wireless end devices (e.g. lower priority user equipments and/or delay tolerant devices) in order to bar their data transmissions. It is emphasized that the base station is not overloaded when the barring message is generated and transmitted. By the mechanisms provided by the present invention, the number of data flows toward a base station can be greatly reduced when the special event happens. As a result, the problems of overload, call drops, and intolerable transmission delays can be mitigated.

### BRIEF DESCRIPTION OF THE DRAWINGS

FIG. 1 illustrates a schematic view of a conventional wireless communication network;

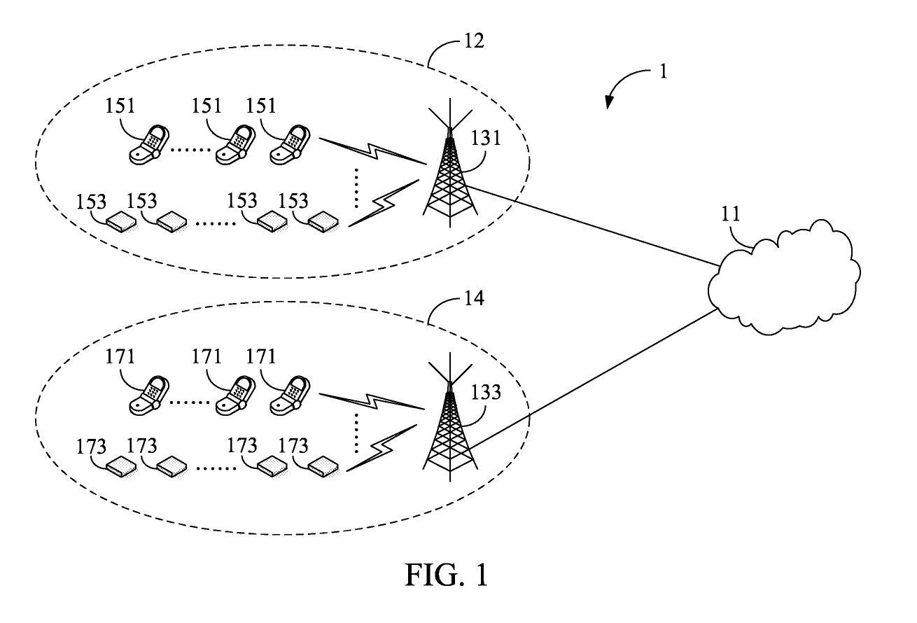

FIG. 2A illustrates a schematic view of a wireless communication network 2 of the first embodiment of the present invention;

FIG. 2B illustrates a block diagram of the base station 231 and a block diagram of the wireless end device 253;

FIG. 3 illustrates the data flows of the second embodiment of the present invention;

FIG. 4 illustrates the data flows of the third embodiment of the present invention;

FIG. 5 illustrates the data flows of the fourth embodiment of the present invention;

FIG. 6 illustrates the data flows of the fifth embodiment of the present invention;

FIG. 7 illustrates the data flows of the sixth embodiment of the present invention;

FIG. 8 illustrates the flowchart of the seventh embodiment of the present invention;

FIG. 9 illustrates the flowchart of the eighth embodiment of the present invention;

FIG. 10 illustrates the flowchart of the ninth embodiment of the present invention;

FIG. 11 illustrates the flowchart of the tenth embodiment of the present invention;

FIG. 12 illustrates the flowchart of the eleventh embodiment of the present invention; and

FIG. 13 illustrates the flowchart of the twelfth embodiment of the present invention.

### DETAILED DESCRIPTION

In the following description, the present invention will be explained with reference to example embodiments thereof. However, these example embodiments are not intended to limit the present invention to any specific examples, embodiments, environment, applications, or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction.

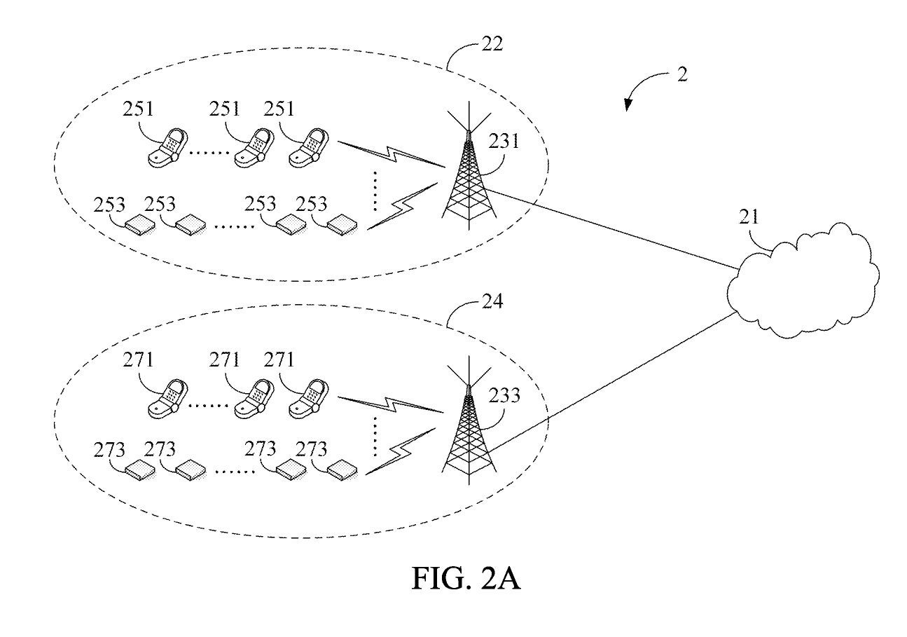

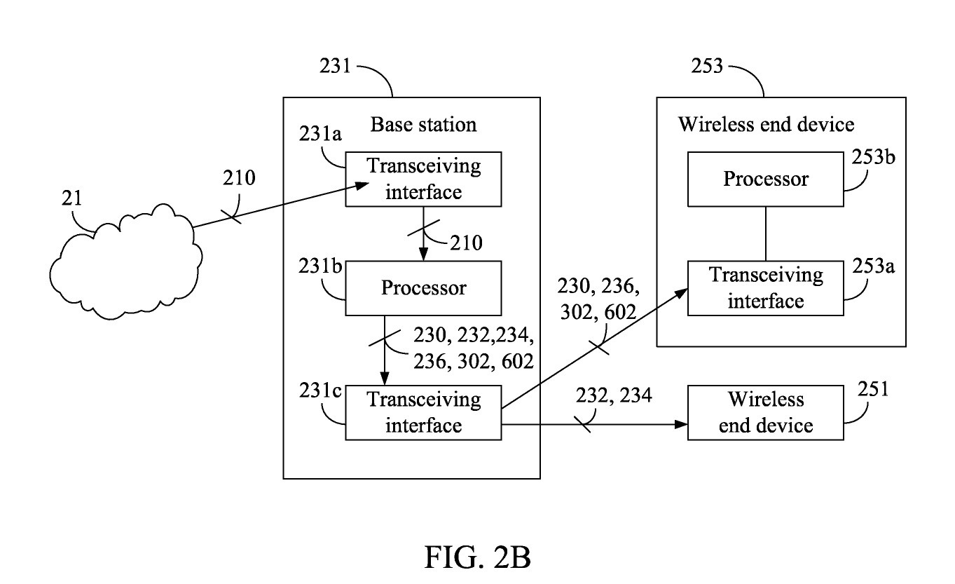

A first embodiment of the present invention is a wireless communication network 2, which is illustrated in FIG. 2A. The wireless communication network 2 may conform to the LTE standard, WiMAX standard, or other wireless communication standard that is well-known to people ordinary skilled in the art. The wireless communication network 2 comprises a core network 21, two base stations 231, 233, and a plurality of wireless end devices 251, 253, 271, 273. It should be noted that the present invention does not limit the number of the base stations and the number of the wireless end devices in a wireless communication network.

The core network 21 may comprise a plurality of entities for providing communication services. For example, the core network 21 may comprise a mobility management entity, a serving gateway, and a packet data network gateway when the wireless communication network 2 conforms to the LTE standard. It should be noted that the present invention does not limit the number and the types of the entities comprised in the core network.

The base stations 231, 233 are electrically connected to the core network 21. The wireless end devices 251, 253 are in the coverage 22 of the base station 231, while the wireless end devices 271, 273 are in the coverage 24 of the base station 233. Among the wireless end devices 251, 253, 271, 273, the wireless end devices 251, 271 have higher priority for transmissions; that is, the wireless end devices 251, 271 may be delay intolerant devices (e.g. user equipments) whose phone calls and/or data transmissions are preferred not to be delayed. On the contrary, the wireless end devices 253, 273 have lower priority for transmissions and whose phone calls and/or data transmissions being delayed causes no harm. For example, the wireless end devices 253, 273 may be delay tolerant devices (e.g. smart meters) that simply periodically transmit collected data to the core network 21 via the base stations 231, 233 or may be user equipments that have lower priorities for transmission.

From the viewpoint of the present invention, the functionalities and operations of the base stations 231, 233 are the same, the functionalities and operations of the wireless end devices 251, 271 are the same, and the functionalities and operations of the wireless end devices 253, 273 are the same, so the following descriptions will focus on the base station 231, one of the wireless end devices 251, one of the wireless end devices 253, and the core network 21.

FIG. 2B illustrates a block diagram of the base station 231 and a block diagram of the wireless end device 253. The base station 231 comprises two transceiving interfaces 231a, 231c and a processor 231b, wherein the processor 231b is electrically connected to the transceiving interfaces 231a, 231c. The wireless end device 253 comprises a transceiving interface 253a and a processor 253b, wherein the transceiving interface 253a is electrically connected to the processor 253b. Each of the transceiving interfaces 231a, 231c, 253a may be any one of various transceiving interfaces that are well known to those of ordinary skill in the art. Each of the processors 231b, 253b may be any one of various processors, central processing units, microprocessors, or other calculating apparatuses that are well known to those of ordinary skill in the art.

When a special event (i.e. an event that may cause a huge amount of data transmission such as an emergency event, an event for new year's countdown, etc.) happens or is going to happen in a short time, a special event notification message 210 is generated by the core network 21 and then received by the transceiving interface 231a of the base station 231. It is noted that when the special event is an emergency event, the special event notification message 210 is an emergency event notification message.

After receiving the special event notification message 210, the base station 231 treats the wireless end devices 251, 253 differently. The wireless end device 253 has lower priority for transmissions, so whose data transmissions will be suspended by the base station 231. On the contrary, the wireless end device 251 has higher priority for transmissions, so whose data transmissions (especially data transmission related to the emergency event) will not be suspended by the base station 231.

To be more specific, after the base station 231 receives the special event notification message 210 for a short time period (e.g. immediately after receiving the special event notification message 210), the processor 231b generates a barring message 230 and an emergency alert indicator 232. The transceiving interface 231c then transmits the barring message 230 and the emergency alert indicator 232 to the wireless end device 253 and the wireless end device 251 respectively. It is noted that the base station 231 is not overloaded when the barring message 230 is generated and transmitted.

The barring message 230 is used to suspend the wireless end device 253 from transmitting data to the base station 231 for a barring time interval (not shown). The barring time interval may be a predetermined one or recorded in the barring message 230. From the viewpoint of the wireless end device 253, the transceiving interface 253a receives the barring message 230 from the base station 231. Similarly, it is noted that the base station 231 is not overloaded when the barring message 230 is received by the wireless end device 253. After receiving the barring message 230, the processor 253b suspends the transceiving interface 253a from transmitting data to the base station 231 for the barring time interval.

As to the emergency alert indicator 232, it is used to enable the wireless end device 251 into an active mode so that the wireless end device 251 can receive emergency related information 234 from the base station 231. Thereafter, the wireless end device 251 can request the base station 231 for making an emergency call and/or transmit data (especially data transmission related to the emergency event) to the base station 231.

If the special event is still happening after a short period of time, the base station 231 may transmit another barring message 236 to the wireless end device 253. After the transceiving interface 253a receives the barring message 236, the processor 253b updates the barring time interval and continues to suspend the transceiving interface 253a for the updated bar time interval. On the contrary, if the special event ends, the transceiving interface 253a can perform data transmission again due to the bar time interval has expired.

For other more complicated embodiments, priorities for transmission may be defined into more than two levels. Each of the wireless end devices 251, 253 is assigned to one of the levels of the priorities. The base station 231 has to inform the wireless end devices 251, 253 of the level(s) of the priority to be barred by sending a barring identity(s). The barring identity(s) may be recorded in the barring message 230 or in another barring message. When the transceiving interface 253a of the wireless end device 253 receives the barring identity, the processor 253b checks whether the barring identity is the same as the level that the wireless end device 253 is assigned to. When the barring identity is the same as the priority that the wireless end device 253 is assigned to, the processor 253b then suspends the transceiving interface 253a from transmitting data to the base station 231 for the barring time interval.

According to the above descriptions, the wireless end devices 251, 253 have different priorities for transmissions when a special event happens. For the wireless end devices 251 (i.e. the ones that have higher priority for transmission), their data transmissions and phone calls will not be suspend during the special event. On the contrary, for the wireless end devices 253 (i.e. the ones that have lower priority for transmission), data transmissions and phone calls will be suspended for the barring time interval. Since the wireless end devices 253 within the coverage 22 of the base station 231 have been suspended from data transmission before the huge amount of data transmission in the wireless communication network 2 really occurs, the number of data flows toward the base station 231 can be reduced. As a result, the problems of overload, call drops, and intolerable transmission delays can be mitigated.

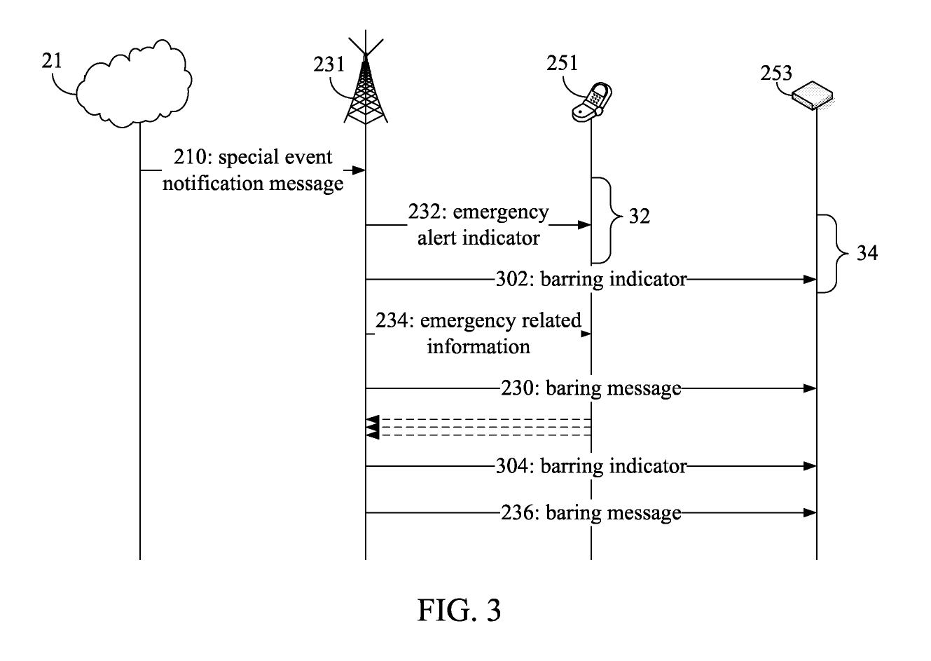

Please refer to FIG. 2A, FIG. 2B, and FIG. 3 for a second embodiment of the present invention. Similar to the first embodiment, the special event notification message 210 is generated by the core network 21 and then received by the transceiving interface 231a of the base station 231 when a special event happens or is going to happen in a short time.

In this embodiment, the processor 231b of the base station 231 generates a barring indicator 302 and the emergency alert indicator 232 after the transceiving interface 231a receives the special event notification message 210. Then, the transceiving interface 231c transmits the barring indicator 302 to the wireless end device 253 within a paging cycle 34 of the wireless end device 253 and transmits the emergency alert indicator 232 to the wireless end device 251 within a paging cycle 32 of the wireless end device 251. It is noted that the base station 231 is not overloaded when the barring indicator 302 is generated and transmitted.

It should be noted that, in some embodiments, the barring indicator 302 may be recorded in a paging message for the wireless end device 253 and the emergency alert indicator 232 may be recorded in a paging message for the wireless end device 251. Yet in some other embodiments, the barring indicator 302 and the emergency alert indicator 232 may be recorded in the same paging message. For the embodiments that the barring indicator 302 and the emergency alert indicator 232 are recorded in a paging message (or paging messages), each of the barring indicator 302 and the emergency alert indicator 232 may be of one bit.

After receiving the emergency alert indicator 232 in its paging cycle 32, the wireless end device 251 becomes active and receives emergency related information 234 recorded in a system information message from the base station 231. Thereafter, the wireless end device 251 can request the base station 231 for making an emergency call and/or transmit data to the base station 231, which is illustrated by the dashed arrows in FIG. 3.

As to the wireless end device 253, the transceiving interface 253a receives the barring indicator 302 in its paging cycle 34. It is noted that the base station 231 is not overloaded when the barring indicator 302 is received by the wireless end device 253. Particularly, when the barring indicator 302 is recorded in a paging message for the wireless end device 253, the transceiving interface 253a receives the barring indicator 302 by receiving the paging message. Then, the transceiving interface 253a receives the barring message 230 recorded in a system information message from the base station 231. It is noted that the base station 231 is not overloaded when the barring message 230 is generated, transmitted, and received. In addition, the base station 231 transmits the barring message 230 by broadcasting or multicasting. In this embodiment, the barring message 230 records the barring time interval and the processor 253b suspends the transceiving interface 253a from transmitting data to the base station 231 for the barring time interval learned from the barring message 230.

If the special event continues after a short period of time, the base station 231 transmits another barring message 236 to the wireless end device 253. After the transceiving interface 253a receives the barring message 236, the processor 253b updates the barring time interval according to the barring time interval recorded in the barring message 236 and continues to suspend the transceiving interface 253a for the updated barring time interval. It is noted that the base station 231 may transmit an additional barring indicator 304 prior to transmitting the barring message 236, which is used to enable other wireless end device(s) 253 from the idle mode into the active mode.

Briefly speaking, the base station 231 simply uses the barring indicator 302 to inform the wireless end device 253 of the activation of the barring mechanism. Upon receiving the barring indicator 302, the wireless end device 253 learns that it has to receive another barring message (i.e. the barring message 230) for the detailed barring information (e.g. barring time interval, barring identity, etc.). Afterwards, the wireless end device 253 is suspended for transmitting data to the base station 231.

In addition to the aforesaid operations, the second embodiment can execute all the operations set forth for the first embodiment. How the second embodiment executes these operations will be readily appreciated by those of ordinary skill in the art based on the explanation of the first embodiment and thus will not be further described therein.

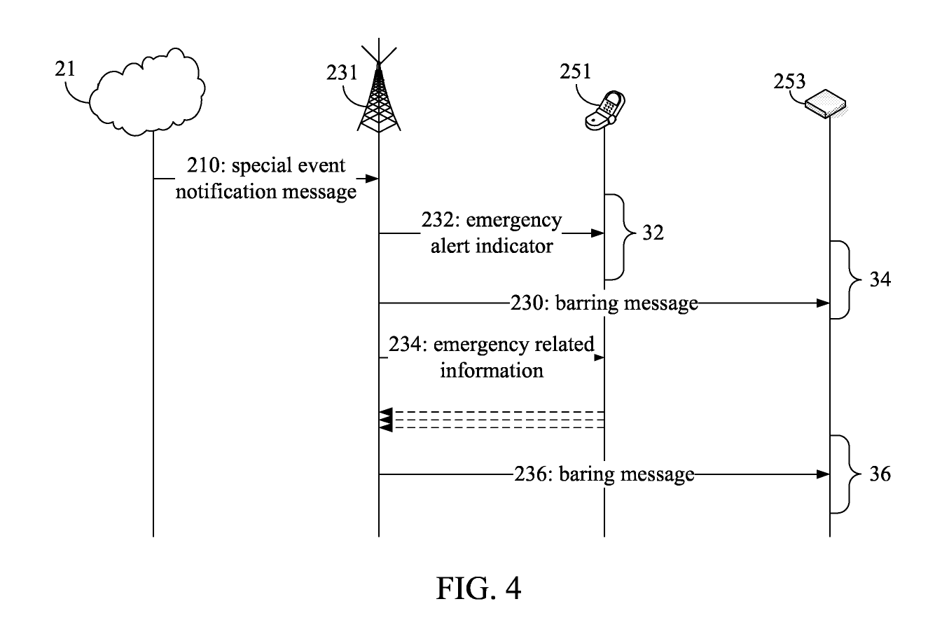

Please refer to FIG. 2A, FIG. 2B, and FIG. 4 for a third embodiment of the present invention. Similar to the first embodiment, the special event notification message 210 is generated by the core network 21 and then received by the transceiving interface 231a of the base station 231 when a special event happens or is going to happen in a short time.

After the transceiving interface 231a receives the special event notification message 210, the processor 231b generates the barring message 230 and the emergency alert indicator 232. Then, the transceiving interface 231c transmits the barring message 230 to the wireless end device 253 within the paging cycle 34 of the wireless end device 253 and transmits the emergency alert indicator 232 to the wireless end device 251 within the paging cycle 32 of the wireless end device 251. The base station 231 is not overloaded when the barring message 230 is generated and transmitted. It should be noted that, in some embodiments, the barring message 230 may be recorded in a paging message for the wireless end device 253 and the emergency alert indicator 232 may be recorded in a paging message for the wireless end device 251. Yet in some other embodiments, the barring message 230 and the emergency alert indicator 232 may be recorded in the same paging message. For those embodiments, each of the barring message 230 and the emergency alert indicator 232 may be of one bit.

After receiving the emergency alert indicator 232 in its paging cycle 32, the wireless end device 251 becomes active and receives emergency related information 234 in system information message from the base station 231. Thereafter, the wireless end device 251 can request the base station 231 for making an emergency call and/or transmit data to the base station 231, which is illustrated by the dashed arrows in FIG. 4.

As to the wireless end device 253, the transceiving interface 253a receives the barring message 230 in its paging cycle 34. Particularly, when the barring message 230 is recorded in a paging message for the wireless end device 253, the transceiving interface 253a receives the barring message 230 by receiving the paging message. The base station 231 is not overloaded when the barring message 230 is received by the wireless end device 253. Then, the processor 253b suspends the transceiving interface 253a from transmitting data to the base station 231 for a barring time interval. It is noted that the barring time interval is a predetermined one.

If the special event continues after a short period of time, the base station 231 transmits another barring message 236 within another paging cycle 36 of the wireless end device 253. After the transceiving interface 253a receives the barring message 236 in the paging cycle 36, the processor 253b suspends the transceiving interface 253a from transmitting data to the base station 231 for the predetermined barring time interval again.

Briefly speaking, the base station 231 simply uses the barring message 230 to inform the wireless end device 253 of the barring information. Upon receiving the barring message 230, the wireless end device 253 learns that it has to be suspended for transmitting data to the base station 231 for the predetermined barring time interval.

In addition to the aforesaid operations, the third embodiment can execute all the operations set forth for the first embodiment. How the third embodiment executes these operations will be readily appreciated by those of ordinary skill in the art based on the explanation of the first embodiment and thus will not be further described therein.

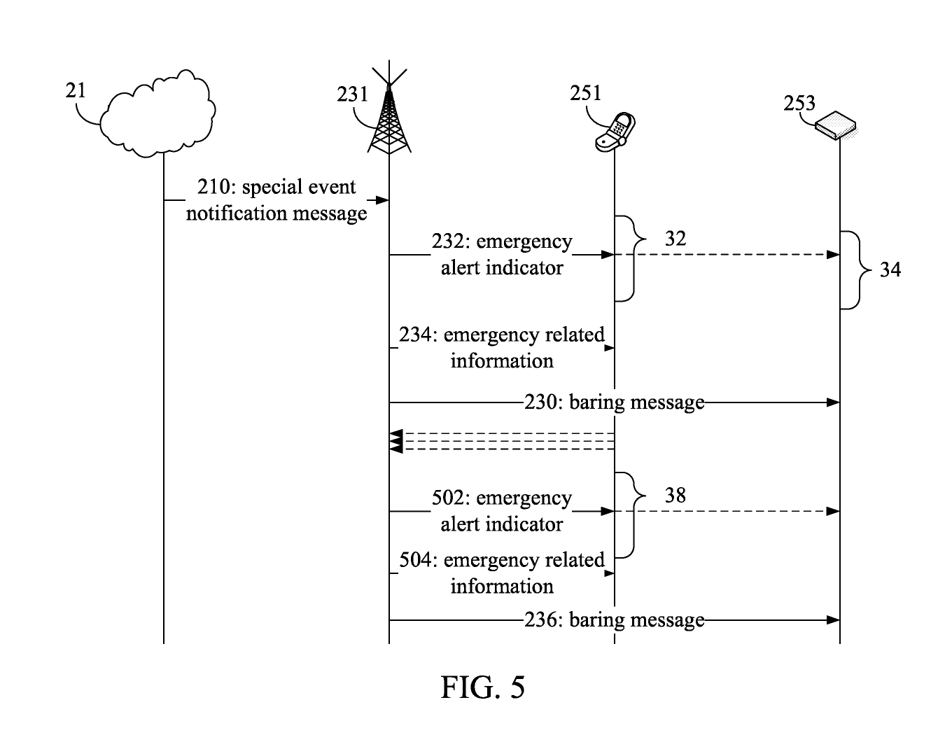

Please refer to FIG. 2A, FIG. 2B, and FIG. 5 for a fourth embodiment of the present invention. Similar to the first to third embodiments, the special event notification message 210 is generated by the core network 21 and then received by the transceiving interface 231a of the base station 231 when a special event happens or is going to happen in a short time.

After the transceiving interface 231a receives the special event notification message 210, the processor 231b generates the emergency alert indicator 232. Then, the transceiving interface 231c transmits the emergency alert indicator 232 to the wireless end device 251 within the paging cycle 32 of the wireless end device 251. It should be noted that, in some embodiments, the emergency alert indicator 232 may be recorded in a paging message for the wireless end device 251 and may be of one bit.

After receiving the emergency alert indicator 232 in its paging cycle 32, the wireless end device 251 becomes active and receives emergency related information 234 recorded in a system information message from the base station 231. Thereafter, the wireless end device 251 can request the base station 231 for making an emergency call and/or transmit data to the base station 231, which is illustrated by the dashed arrows in FIG. 5.

As to the wireless end device 253, its paging cycle 34 and the paging cycle 32 of the wireless end device 251 overlap, so the transceiving interface 253a can listen for emergency alert indicator within the paging cycle 34. After the transceiving interface 253a listens to the emergency alert indicator 232 within the paging cycle 34, the processor 253b enables the transceiving interface 253a into an active mode. Then, the transceiving interface 253a receives the barring message 230 recorded in a system information message from the base station 231. The barring message 230 is transmitted from the base station 231 by broadcasting or multicasting. The barring message 230 records the barring time interval and the processor 253b then suspends the transceiving interface 253a from transmitting data to the base station 231 for the barring time interval learned from the barring message 230. It is noted that the base station 231 is not overloaded when the barring message 230 is generated, transmitted, and received.

It should be emphasized that the present invention does not limit the transmission sequence of the emergency related information 234 and the barring message 230. That is, after transmitting the emergency alert indicator 232, the base station 231 may transmit the emergency related information 234 and the barring message 230 in any sequence.

If the special event continues after a short period of time, the base station 231 transmits another barring message 236 to the wireless end device 253. After the transceiving interface 253a receives the barring message 236, the processor 253b updates the barring time interval according to the barring time interval recorded in the barring message 236 and continues to suspend the transceiving interface 253a for the updated barring time interval. It is noted that, prior to transmitting the barring message 236, the base station 231 may transmit an additional emergency alert indicator 502 within another paging cycle 38 and another emergency related information 504 to other wireless end device(s) 251.

Likewise, it should be emphasized that the present invention does not limit the transmission sequence of the emergency related information 504 and the barring message 236. That is, after transmitting the emergency alert indicator 502, the base station 231 may transmit the emergency related information 504 and the barring message 236 in any sequence.

Briefly speaking, the wireless end device 253 listens for an emergency alert indicator 232 that is transmitted to the wireless end device 251. Upon listening to the emergency alert indicator 232, the wireless end device 253 learns that it has to receive a barring message (i.e. the barring message 230) for the detailed barring information (e.g. barring time interval, barring identity, etc.). Afterwards, the wireless end device 253 is suspended for transmitting data to the base station 231.

In addition to the aforesaid operations, the fourth embodiment can execute all the operations set forth for the first embodiment. How the fourth embodiment executes these operations will be readily appreciated by those of ordinary skill in the art based on the explanation of the first embodiment and thus will not be further described therein.

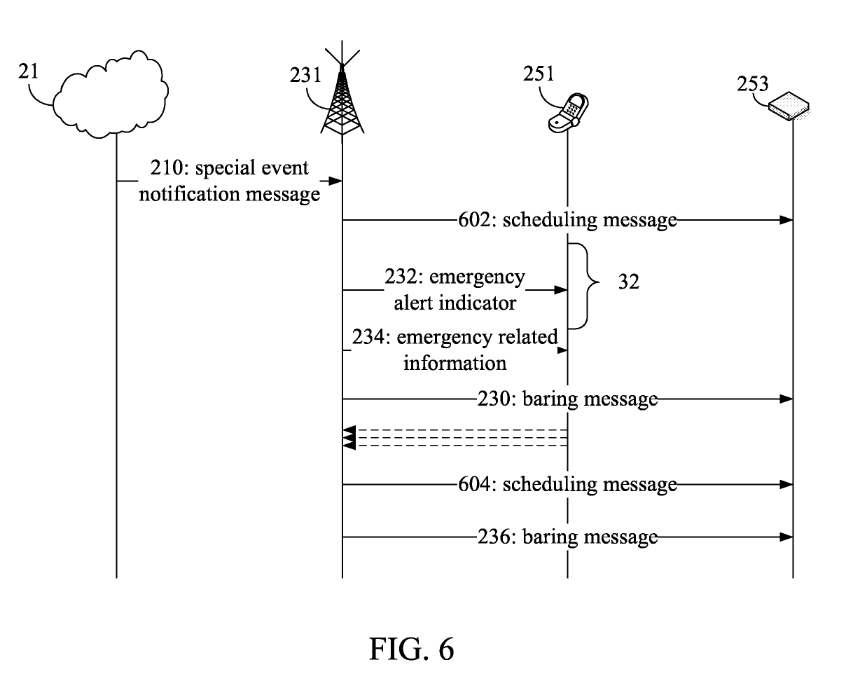

Please refer to FIG. 2A, FIG. 2B, and FIG. 6 for a fifth embodiment of the present invention. Similar to the first to fourth embodiments, the special event notification message 210 is generated by the core network 21 and then received by the transceiving interface 231a of the base station 231 when a special event happens or is going to happen in a short time.

In this embodiment, the processor 231b of the base station 231 generates a scheduling message 602 of a plurality of system information blocks after the transceiving interface 231a receives the special event notification message 210. Then, the transceiving interface 231c broadcasts the scheduling message 602 during a system information transmission interval. From the viewpoint of the wireless end device 253, its transceiving interface 253a receives the scheduling message 602 and learns the arrangement of the system information blocks. Next, the transceiving interface 253a receives the barring message 230 recorded in at least one of the system information blocks according to the arrangement indicated by the scheduling message 602. The barring message 230 records the barring time interval and the processor 253b suspends the transceiving interface 253a from transmitting data to the base station 231 for the barring time interval learned from the barring message 230. It should be noted that the barring message 230 may be recorded in the scheduling message 602 in some other embodiments. In addition, it is emphasized that the base station 231 is not overloaded when the barring message 230 is generated, transmitted, and received.

In this embodiment, the processor 231b also generates an emergency alert indicator 232 after the transceiving interface 231a receives the special event notification message 210. Then, the transceiving interface 231c transmits the emergency alert indicator 232 to the wireless end device 251 within the paging cycle 32 of the wireless end device 251. It should be noted that, in some embodiments, the emergency alert indicator 232 may be recorded in a paging message for the wireless end device 251. For those embodiments, the emergency alert indicator 232 may be of one bit.

After receiving the emergency alert indicator 232 in its paging cycle 32, the wireless end device 251 becomes active and receives emergency related information 234 recorded in a system information message from the base station 231, wherein the system information message may be one of the aforementioned system information blocks. Thereafter, the wireless end device 251 can request the base station 231 for making an emergency call and/or transmit data to the base station 231, which is illustrated by the dashed arrows in FIG. 6.

It should be emphasized that the present invention does not limit the transmission sequence of the emergency related information 234 and the barring message 230; that is, the time instant for transmitting the emergency related information 234 may be prior to, later to, or at the same as the time instant for transmitting the barring message 230.

If the special event continues after a short period of time, the base station 231 transmits another scheduling message 604 of other system information blocks and another barring message 236 to the wireless end device 253. After the transceiving interface 253a receives the barring message 236, the processor 253b updates the barring time interval according to the barring time interval recorded in the barring message 236 and continues to suspend the transceiving interface 253a for the updated barring time interval.

Briefly speaking, the base station 231 broadcasts the scheduling message 602 of the system information blocks. The wireless end device 253 learns that it has to receive the barring message 230 for the detailed barring information (e.g. barring time interval, barring identity, etc.) according to the scheduling message 602. Afterwards, the wireless end device 253 is suspended for transmitting data to the base station 231.

In addition to the aforesaid operations, the fifth embodiment can execute all the operations set forth for the first embodiment. How the fifth embodiment executes these operations will be readily appreciated by those of ordinary skill in the art based on the explanation of the first embodiment and thus will not be further described therein.

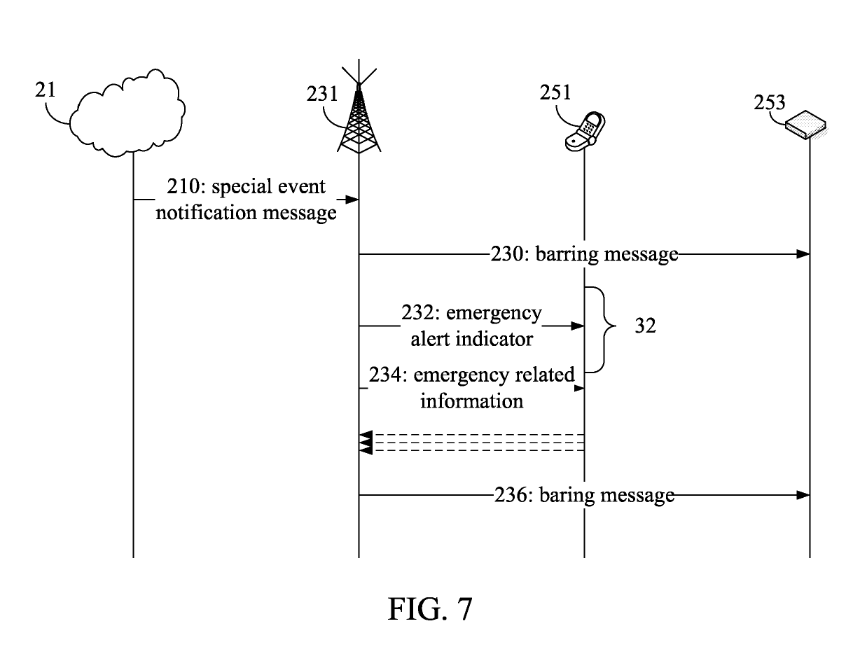

Please refer to FIG. 2A, FIG. 2B, and FIG. 7 for a sixth embodiment of the present invention. Similar to the first to fifth embodiments, the special event notification message 210 is generated by the core network 21 and then received by the transceiving interface 231a of the base station 231 when a special event happens or is going to happen in a short time.

After the transceiving interface 231a receives the special event notification message 210, the processor 231b generates the emergency alert indicator 232. Then, the transceiving interface 231c transmits the emergency alert indicator 232 to the wireless end device 251 within the paging cycle 32 of the wireless end device 251. It should be noted that, in some embodiments, the emergency alert indicator 232 may be recorded in a paging message for the wireless end device 251. For those embodiments, the emergency alert indicator 232 may be of one bit.

After receiving the emergency alert indicator 232 in its paging cycle 32, the wireless end device 251 becomes active and receives emergency related information 234 recorded in a system information message from the base station 231. Thereafter, the wireless end device 251 can request the base station 231 for making an emergency call and/or transmit data to the base station 231, which is illustrated by the dashed arrows in FIG. 7.

The processor 231b of the base station 231 also generates the barring message 230 and the transceiving interface 231c then transmits the barring message 230 to the wireless end device 253 by broadcasting. The base station 231 is not overloaded when the barring message 230 is generated and transmitted. In some other embodiments, the barring message 230 may be recorded in a master information block or a system information block. When the barring message 230 is recorded in master information block, it may be of one bit.

From the viewpoint of the wireless end device 253, its transceiving interface 253a receives the barring message 230. It is noted that the base station 231 is not overloaded when the barring message 230 is received by the wireless end device 253. Then, the processor 253b suspends the transceiving interface 253a from transmitting data to the base station 231 for a barring time interval. It is noted that the barring time interval is a predetermined one.

If the special event continues after a short period of time, the base station 231 transmits another barring message 236 to the wireless end device 253 by broadcasting again. Likewise, the barring message 230 may be recorded in a master information block or a system information block. After the transceiving interface 253a receives the barring message 236, the processor 253b suspends the transceiving interface 253a from transmitting data to the base station 231 for the predetermined barring time interval again.

Briefly speaking, the base station 231 broadcasts the barring message 230 in a master information block or a system information block. Upon receiving the barring message 230, the wireless end device 253 learns that it has to be suspended for transmitting data to the base station 231 for the predetermined barring time interval. In addition to the aforesaid operations, the sixth embodiment can execute all the operations set forth for the first embodiment. How the sixth embodiment executes these operations will be readily appreciated by those of ordinary skill in the art based on the explanation of the first embodiment and thus will not be further described therein.

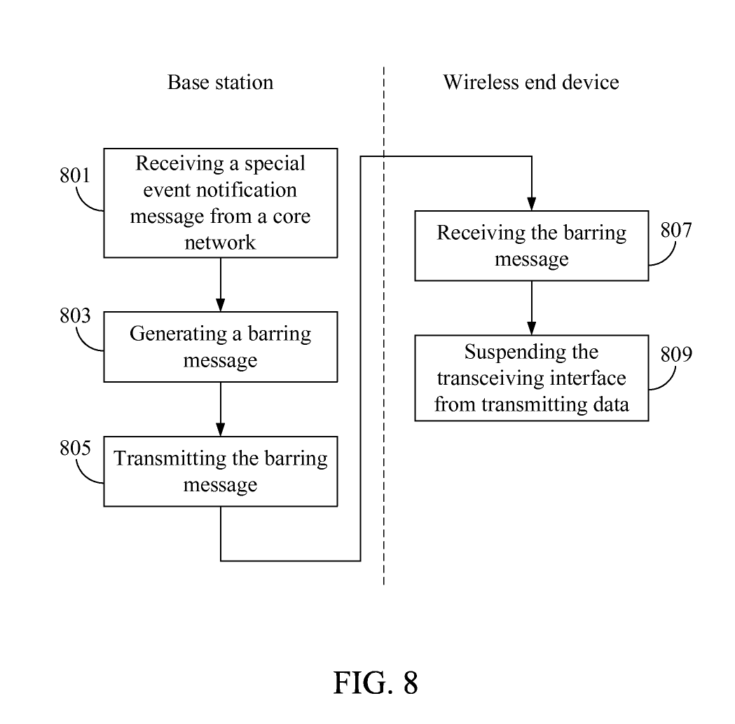

A seventh embodiment of the present invention is a transmission barring method, whose flowchart is illustrated in FIG. 8. The transmission barring method can be used for a wireless communication network comprising a core network, a base station, and a wireless end device. The wireless end device has a lower priority for transmission in the wireless communication network. For example, the wireless end device may be a delay tolerant device. The base station comprises a first transceiving interface, a processor, and a second transceiving interface, while the wireless end device comprises a processor and a transceiving interface.

When a special event happens or is going to happen in a short time, the core network transmits a special event notification message. Afterwards, step 801 is executed by the first transceiving interface of the base station for receiving the special event notification message from the core network. Then, step 803 is executed by the processor of the base station for generating a barring message. Next, step 805 is executed by the second transceiving interface of the base station for transmitting the barring message to the wireless end device.

From the viewpoint of the wireless end device, step 807 is executed by the transceiving interface of the wireless end device for receiving the barring message. Next, step 809 is executed by the processor of the wireless end device for suspending the transceiving interface of the wireless end device from transmitting data to the base station for a barring time interval. It is noted that the barring time interval may be a predetermined one or may be recorded in the barring message. It is noted that the base station is not overloaded when the aforesaid steps 803, 805, and 807 are executed.

In case that the special event continues, the transmission barring method repeats the aforementioned steps 803, 805, 807, and 809 and the wireless end device will updates the barring time interval accordingly.

It is noted that, in some embodiments, the barring message generated in step 803 may record an identity indicating which wireless end device to be suspended. In this way, the wireless end device has to execute another step after the step 807 to determine whether the identity recoded in the barring message is the same as the identity of the wireless end device. The wireless end device will execute step 809 only when the two identities are the same.

In addition to the aforesaid steps, the seventh embodiment can execute all the operations set forth for the first embodiment. How the seventh embodiment executes these operations will be readily appreciated by those of ordinary skill in the art based on the explanation of the first embodiment and thus will not be further described therein.

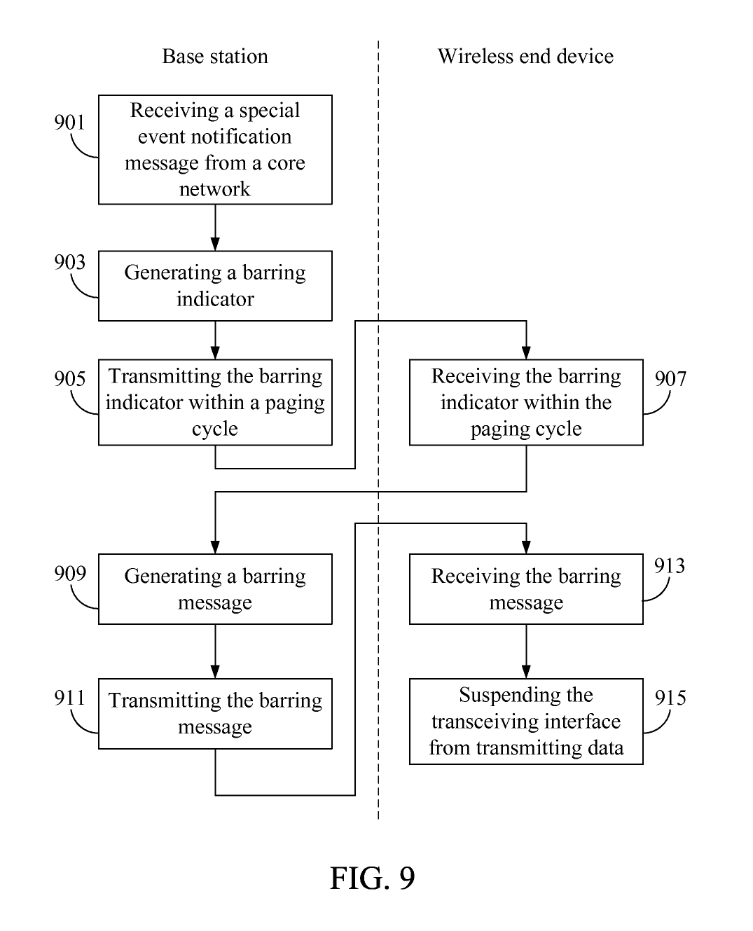

An eighth embodiment of the present invention is a transmission barring method, whose flowchart is illustrated in FIG. 9. The transmission barring method can be used for a wireless communication network comprising a core network, a base station, and a wireless end device. The wireless end device has a lower priority for transmission in the wireless communication network. For example, the wireless end device may be a delay tolerant device. The base station comprises a first transceiving interface, a processor, and a second transceiving interface, while the wireless end device comprises a processor and a transceiving interface.

When a special event happens or is going to happen in a short time, the core network transmits a special event notification message. Afterwards, step 901 is executed by the first transceiving interface of the base station for receiving the special event notification message from the core network. Next, step 903 is executed by the processor of the base station for generating a barring indicator. Following that, step 905 is executed by the second transceiving interface of the base station for transmitting the barring indicator to the wireless end device within a paging cycle of the wireless end device. Next, step 907 is executed by the transceiving interface of the wireless end device to receive the barring indicator within its paging cycle.

It is noted that, in some embodiment, the barring indicator may be recorded in a paging message. Hence, step 905 transmits the barring indicator by transmitting the paging message, while step 907 receives the barring indicator by receiving the paging message.

Following that, step 909 is executed by the processor of the base station for generating a barring message. It is noted that the barring message generated in step 909 comprises additional barring information, such as the barring time interval, barring identity, etc. Step 911 is then executed by the second transceiving interface of the base station for transmitting the barring message to the wireless end device. Next, step 913 is executed by the transceiving interface of the wireless end device for receiving the barring message. Afterwards, the wireless end device derives the barring time interval and its processor executes step 915 for suspending its transceiving interface from transmitting data to the base station for the barring time interval. It is noted that the base station is not overloaded when the steps 903, 905, 907, 909, 911, and 913 are executed.

In case that the special event continues, the transmission barring method repeats the aforementioned steps 909, 911, 913, and 915 and the wireless end device will updates the barring time interval accordingly.

In addition to the aforesaid steps, the eighth embodiment can execute all the operations set forth for the second embodiment. How the eighth embodiment executes these operations will be readily appreciated by those of ordinary skill in the art based on the explanation of the second embodiment and thus will not be further described therein.

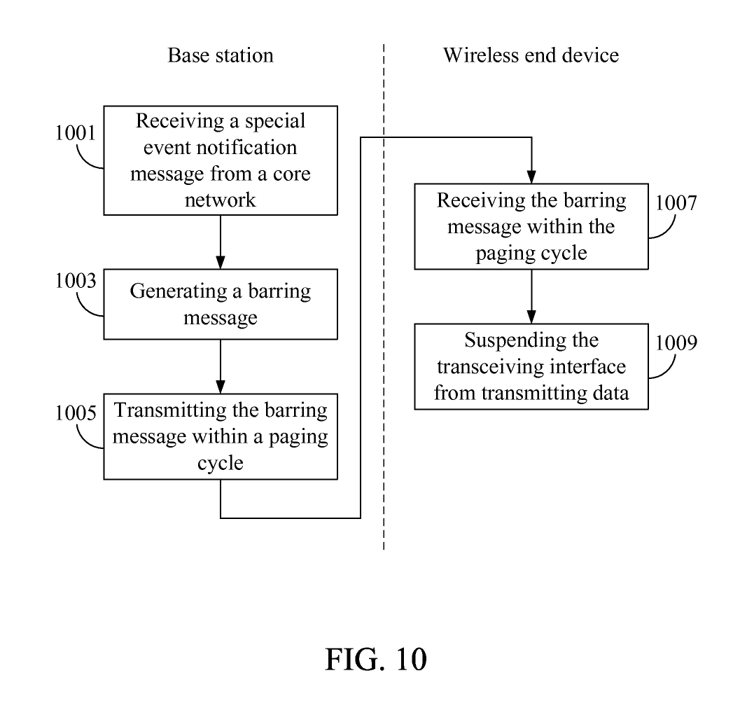

A ninth embodiment of the present invention is a transmission barring method, whose flowchart is illustrated in FIG. 10. The transmission barring method can be used for a wireless communication network comprising a core network, a base station, and a wireless end device. The wireless end device has a lower priority for transmission in the wireless communication network. For example, the wireless end device may be a delay tolerant device. The base station comprises a first transceiving interface, a processor, and a second transceiving interface, while the wireless end device comprises a processor and a transceiving interface.

When a special event happens or is going to happen, the core network transmits a special event notification message. Afterwards, step 1001 is executed by the first transceiving interface of the base station for receiving the special event notification message from the core network. Then, step 1003 is executed by the processor of the base station for generating a barring message. Next, step 1005 is executed by the second transceiving interface of the base station for transmitting the barring message to the wireless end device within a paging cycle of the wireless end device.

From the viewpoint of the wireless end device, step 1007 is executed by the transceiving interface of the wireless end device for receiving the barring message within its paging cycle. It is noted that the base station is not overloaded when the steps 1003, 1005, and 1007 are executed. Next, step 1009 is executed by the processor of the wireless end device for suspending the transceiving interface of the wireless end device from transmitting data to the base station for a barring time interval. It is noted that the barring time interval may be a predetermined one or may be recorded in the barring message.

In case that the special event continues, the transmission barring method repeats the aforementioned steps 1003, 1005, 1007, and 1009 and the wireless end device will updates the barring time interval accordingly.

In addition to the aforesaid steps, the ninth embodiment can execute all the operations set forth for the third embodiment. How the ninth embodiment executes these operations will be readily appreciated by those of ordinary skill in the art based on the explanation of the third embodiment and thus will not be further described therein.

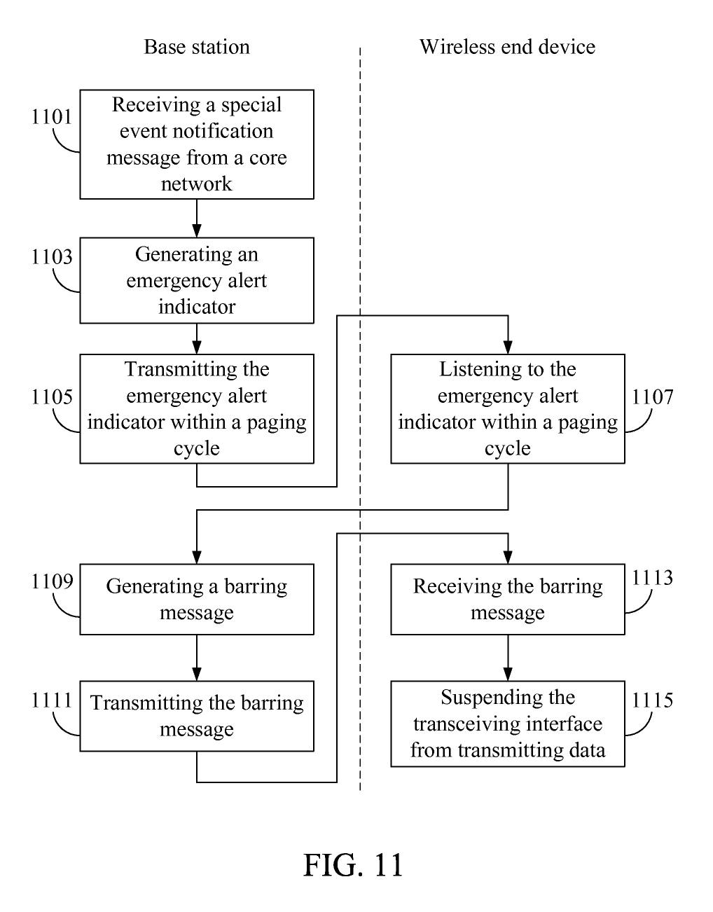

A tenth embodiment of the present invention is a transmission barring method, whose flowchart is illustrated in FIG. 11. The transmission barring method can be used for a wireless communication network comprising a core network, a base station, a first wireless end device, and a second wireless end device. The second wireless end device has a higher priority for transmission, while the first wireless end device has a lower priority for transmission. The base station comprises a first transceiving interface, a processor, and a second transceiving interface, while the first wireless end device comprises a processor and a transceiving interface.

When a special event happens or is going to happen, the core network transmits a special event notification message. Afterwards, step 1101 is executed by the first transceiving interface of the base station for receiving the special event notification message from the core network. Next, step 1103 is executed by the processor of the base station for generating an emergency alert indicator. Following that, step 1105 is executed by the second transceiving interface of the base station for transmitting the emergency alert indicator to the second wireless end device within a paging cycle of the second wireless end device.

Next, step 1107 is executed by the transceiving interface of the first wireless end device for listening to the emergency alert indicator within a paging cycle of the first wireless end device. This is feasible because the paging cycle of the first wireless end device overlaps that of the second wireless end device. By listening to the emergency alert indicator, the first wireless end device learns that it has to receive a barring message later.

Following that, step 1109 is executed by the processor of the base station for generating the barring message, which may comprise additional barring information, such as the barring time interval. Step 1111 is then executed by the second transceiving interface of the base station for transmitting the barring message to the first wireless end device. Next, step 1113 is executed by the transceiving interface of the first wireless end device for receiving the barring message. It is emphasized that the base station is not overloaded when the steps 1109, 1111, and 1113 are executed. Afterwards, the first wireless end device derives the barring time interval and its processor executes step 1113 for suspending its transceiving interface from transmitting data to the base station for the barring time interval.

In case that the special event continues, the transmission barring method repeats the aforementioned steps 1109, 1111, 1113, and 1115 and the first wireless end device will updates the barring time interval accordingly.

In addition to the aforesaid steps, the tenth embodiment can execute all the operations set forth for the fourth embodiment. How the tenth embodiment executes these operations will be readily appreciated by those of ordinary skill in the art based on the explanation of the fourth embodiment and thus will not be further described therein.

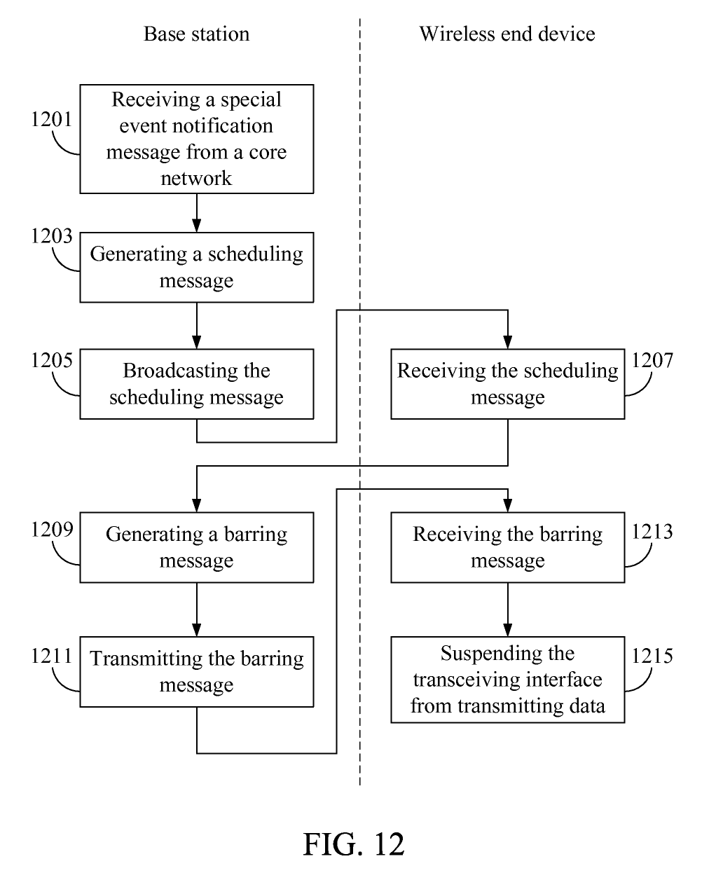

An eleventh embodiment of the present invention is a transmission barring method, whose flowchart is illustrated in FIG. 12. The transmission barring method can be used for a wireless communication network comprising a core network, a base station, and a wireless end device. The wireless end device has a lower priority for transmission in the wireless communication network. For example, the wireless end device may be a delay tolerant device. The base station comprises a first transceiving interface, a processor, and a second transceiving interface, while the wireless end device comprises a processor and a transceiving interface.

When a special event happens or is going to happen in a short time, the core network transmits a special event notification message. Afterwards, step 1201 is executed by the first transceiving interface of the base station for receiving the special event notification message from the core network. Next, step 1203 is executed by the processor of the base station for generating a scheduling message of a plurality of system information blocks. Following that, step 1205 is executed by the second transceiving interface of the base station for broadcasting the scheduling message. Next, step 1207 is executed by the transceiving interface of the wireless end device to receive the scheduling message. From the scheduling message, the wireless end device learns the time to receive a barring message.

Following that, step 1209 is executed by the processor of the base station for generating a barring message, which comprises additional barring information, such as the barring time interval. Step 1211 is then executed by the second transceiving interface of the base station for transmitting the barring message to the wireless end device. Next, step 1213 is executed by the transceiving interface of the wireless end device for receiving the barring message. It is noted that the base station is not overloaded when the steps 1209, 1211, and 1213 are executed. Afterwards, the wireless end device derives the barring time interval and its processor executes step 1215 for suspending its transceiving interface from transmitting data to the base station for the barring time interval.

In case that the special event continues, the transmission barring method repeats the aforementioned step 1205 to step 1215 and the wireless end device will updates the barring time interval accordingly.

In addition to the aforesaid steps, the eleventh embodiment can execute all the operations set forth for the fifth embodiment. How the eleventh embodiment executes these operations will be readily appreciated by those of ordinary skill in the art based on the explanation of the fifth embodiment and thus will not be further described therein.

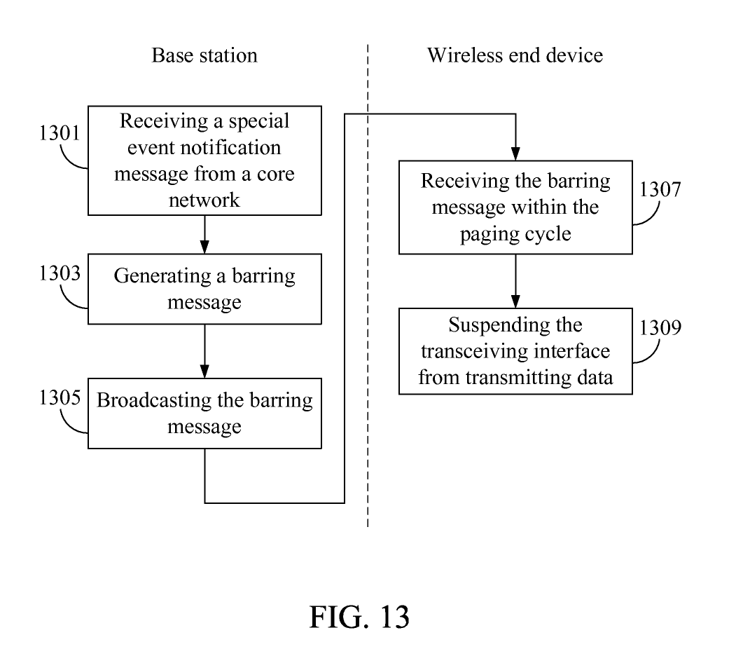

A twelfth embodiment of the present invention is a transmission barring method, whose flowchart is illustrated in FIG. 13. The transmission barring method can be used for a wireless communication network comprising a core network, a base station, and a wireless end device. The wireless end device has a lower priority for transmission in the wireless communication network. For example, the wireless end device may be a delay tolerant device. The base station comprises a first transceiving interface, a processor, and a second transceiving interface, while the wireless end device comprises a processor and a transceiving interface.

When a special event happens or is going to happen in a short time, the core network transmits a special event notification message. Afterwards, step 1301 is executed by the first transceiving interface of the base station for receiving the special event notification message from the core network. Then, step 1303 is executed by the processor of the base station for generating a barring message in one of a master information block and a system information block. Next, step 1305 is executed by the second transceiving interface of the base station for transmitting the barring message by broadcasting the master information block or the system information block (depending on which one comprises the barring message).

From the viewpoint of the wireless end device, step 1307 is executed by the transceiving interface of the wireless end device for receiving the barring message. It is noted that the base station is not overloaded when the steps 1303, 1305, and 1307 are executed. Next, step 1309 is executed by the processor of the wireless end device for suspending the transceiving interface of the wireless end device from transmitting data to the base station for a barring time interval. It is noted that the barring time interval may be a predetermined one or may be recorded in the barring message.

In case that the special event continues, the transmission barring method repeats the aforementioned steps 1303, 1305, 1307, and 1309 and the wireless end device will updates the barring time interval accordingly.

In addition to the aforesaid steps, the twelfth embodiment can execute all the operations set forth for the sixth embodiment. How the twelfth embodiment executes these operations will be readily appreciated by those of ordinary skill in the art based on the explanation of the sixth embodiment and thus will not be further described therein.

According to the above embodiments, wireless end devices of a wireless communication network have different priorities for transmissions when a special event happens or is going to happen in a short time. For wireless end devices that have higher priority for transmission, their data transmissions and phone calls will not be suspend during the special event. On the contrary, for the wireless end devices that have lower priority for transmission, their data transmissions and phone calls will be suspended for the barring time interval. By the mechanisms provided by the present invention, the number of data flows toward a base station can be greatly reduced when the special event happens. As a result, the problems of overload, call drops, and intolerable transmission delays can be mitigated.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station, comprising:
a first transceiving interface, being configured to receive a special event notification message from a core network;
a processor, being electrically connected to the first transceiving interface and configured to generate a barring message after the first transceiving interface receives the special event notification message; and
a second transceiving interface, being electrically connected to the processor and configured to transmit the barring message to a first wireless end device to suspend the first wireless end device from transmitting data to the base station for a barring time interval,
wherein the base station is not overloaded when the barring message is generated and transmitted.

2. The base station of claim 1, wherein the processor further generates a barring indicator after the first transceiving interface receives the special event notification message, the second transceiving interface further transmits the barring indicator to the first wireless end device within a paging cycle of the first wireless end device, and the barring indicator is transmitted prior to the barring message.

3. The base station of claim 2, wherein the barring indicator is recorded in a paging message and the barring message records the barring time interval.

4. The base station of claim 1, wherein the second transceiving interface transmits the barring message to the first wireless end device within a paging cycle of the first wireless end device.

5. The base station of claim 1, wherein the processor further generates an emergency alert indicator, the second transceiving interface further transmits the emergency alert indicator to a second wireless end device within a paging cycle of the second wireless end device, and the emergency alert indicator is transmitted prior to the barring message.

6. The base station of claim 1, wherein the processor further generates a scheduling message of a plurality of system information blocks, the second transceiving interface further broadcasts the scheduling message before transmitting the barring message, and the barring message is transmitted in at least one of the system information blocks.

7. The base station of claim 1, wherein the barring message is recorded in one of a master information block and a system information block, and the second transceiving interface transmits the barring message by broadcasting.

8. A wireless end device, comprising:
a transceiving interface, being configured to receive a barring message from a base station, wherein the base station is not overloaded when the barring message is received by the wireless end device; and
a processor, being electrically connected to the transceiving interface and configured to suspend the transceiving interface from transmitting data to the base station for a barring time interval.

9. The wireless end device of claim 8, wherein the transceiving interface further receives a barring indicator within a paging cycle and the barring indicator is received prior to the barring message.

10. The wireless end device of claim 9, wherein the transceiving interface receives the barring indicator by receiving a paging message and the barring message records the barring time interval.

11. The wireless end device of claim 8, wherein the transceiving interface receives the barring message within a paging cycle.

12. The wireless end device of claim 8, wherein the transceiving interface further listens to an emergency alert indicator within a paging cycle and the processor further enables the transceiving interface into an active mode for receiving the barring message.

13. The wireless end device of claim 8, wherein the transceiving interface further receives a scheduling message of a plurality of system information blocks and the barring message is received by the transceiving interface in at least one of the system information blocks.

14. The wireless end device of claim 8, wherein the barring message is recorded in one of a master information block and a system information block.

15. A transmission barring method for use in a base station, the base station comprising a first transceiving interface, a second transceiving interface, and a processor, the transmission barring method comprising the steps of:
receiving, by the first transceiving interface, a special event notification message from a core network;
generating, by the processor, a barring message after receiving the special event notification message; and
transmitting, by the second transceiving interface, the barring message to a first wireless end device to suspend the first wireless end device from transmitting data to the base station for a barring time interval,
wherein the base station is not overloaded when the barring message is generated and transmitted.

16. The transmission barring method of claim 15, further comprising the steps of:
generating, by the processor, a barring indicator after receiving the special event notification message; and
transmitting, by the second transceiving interface, the barring indicator to the first wireless end device within a paging cycle of the first wireless end device;
wherein the barring indicator is transmitted prior to the barring message.

17. The transmission barring method of claim 16, wherein the barring indicator is recorded in a paging message and the barring message records the barring time interval.

18. The transmission barring method of claim 15, wherein the barring message is transmitted to the first wireless end device within a paging cycle of the first wireless end device.

19. The transmission barring method of claim 15, further comprising the steps of:
generating, by the processor, an emergency alert indicator; and
transmitting, by the second transceiving interface, the emergency alert indicator to a second wireless end device within a paging cycle of the second wireless end device;
wherein the emergency alert indicator is transmitted prior to the barring message.

20. The transmission barring method of claim 15, further comprising the steps of:
generating, by the processor, a scheduling message of a plurality of system information blocks; and
broadcasting, by the second transceiving interface, the scheduling message before transmitting the barring message;
wherein the barring message is transmitted in at least one of the system information blocks.

21. The transmission barring method of claim 15, wherein the barring message is recorded in one of a master information block and a system information block and the second transceiving interface transmits the barring message by broadcasting.

22. A transmission barring method for use in a wireless end device, the wireless end device comprising a transceiving interface and a processor, the transmission barring method comprising the steps of:
receiving, by the transceiving interface, a barring message from a base station; and
suspending, by the processor, the transceiving interface from transmitting data to the base station for a barring time interval, wherein the base station is not overloaded when the barring message is received by the wireless end device.

23. The transmission barring method of claim 22, further comprising the steps of:
receiving, by the transceiving interface, a barring indicator within a paging cycle;
wherein the barring indicator is received prior to the barring message.

24. The transmission barring method of claim 23, wherein the transmission barring method receives the barring indicator by receiving a paging message and the barring message records the barring time interval.

25. The transmission barring method of claim 22, wherein the barring message is received within a paging cycle.

26. The transmission barring method of claim 22, further comprising the steps of:
listening to, by the transceiving interface, an emergency alert indicator within a paging cycle; and
enabling, by the processor, the transceiving interface into an active mode for receiving the barring message.

27. The transmission barring method of claim 22, further comprising the steps of:
receiving, by the transceiving interface, a scheduling message of a plurality of system information blocks;
wherein the barring message is in at least one of the system information blocks.

28. The transmission barring method of claim 22, wherein the barring message is recorded in one of a master information block and a system information block.
